(19) United States
(12) Patent Application Publication
(10) Pub. No.: US 2007/0101780 A1
(43) Pub. Date: May 10, 2007

(54) Semirigid motorcycle saddlebag lock assembly

(76) Inventor: Dean G. Sanders, Linden, CA (US)

Correspondence Address: K Brian Matlock, 1004 Northoak Dr., Walnut Creek, CA, 94598, US

(21) Appl. No.: 11/268,067

(22) Filed: Nov. 7, 2005

(51) Int. Cl. E05B 71/00

(52) U.S. Cl. 70/233

(57) ABSTRACT

A road saddlebag branded emblem aftermarket lock and latch assembly for a left, right, and rear mount saddlebag apparatus. It provides branded emblem faceplate locking feature and stylized, high security motorcycle and rider gear stowage. It also provides a method for providing stylistic and high security locking feature on a road saddlebags. It can be easily adapted to various types of stylistic, branded emblem designs of the specific faceplate logo and classic road bike, motorcycle designs and that the security locking system is not dependant upon a branded cover plate emblem. It provides tamperproof lock and latch mechanism apparatus security by utilizing the rotary latch full encapsulating threaded post and tamper restricting lock guard cover of the lock mechanism. It provides a means for resisting tampering and defeating of the lock mechanism through collapsing or deforming the semi-rigid leather saddlebag in order to defeat the integrity of the locking mechanism.

### BACKGROUND

1. Field of the Disclosure

The present disclosure relates to semi-rigid, leather covered saddlebags aftermarket accessories for distinct style classic road bikes. More particularly, the present disclosure is a locking latch and receptacle mechanism for a leather left, right and rear mount saddlebag assembly for such classic road bike, motorcycle styles. The subject matter herein relates generally to a rotary latch and keyed lock mechanism to provide secure, tamper proof locking functionality to the semi-rigid leather saddlebag. Further, the subject matter also relates generally to rotary latch functionality by providing a full encapsulation of lower faceplate mating strike post and upper rotary latch mechanism.

2. The Prior Art

### BACKGROUND

Side, rear mount, semi-rigid leather covered saddlebags are well known in the art. One known type of such saddlebags includes a non-locking pouch for the stowage of rider's gear. The popular configuration of the non-locking pouch includes a branded faceplate. Further, a locking saddlebag is also well known in the art. However, the push-button style, spring biased design is a low security device that does not safely stow a riders gear from tampering and theft. Also, the functional nature of the lock mounted upon the strap of the saddlebag does not provide for stylistic and distinctive marketing logos, and does not provide significant security for the articles stowed within the compartment. The present invention provides a novel high security locking mechanism while maintaining the current shaped, stylized branded faceplate of the manufacturers original design. In one embodiment of the present disclosure, a pivot mechanism is provided for the original manufacturers distinctive escutcheon plate to serve as a cover for the locking mechanism. No such high security and aesthetic feature currently exists in present designs. However, motorcycle riders have long felt the need for a locking mechanism that retains the bike's classic styling and functional location while simultaneously providing secure, lockable, tamper proof functionality to enhance the privacy and security of the external rear and side mounted saddlebag assembly. Previous versions of the specific brand, emblem faceplate were affixed and mounted to the saddlebag through the use of rivet fasteners. The rotary latch and keyed lock mechanism provides secure, tamper proof locking functionality to the semi-rigid leather saddlebag. Further, the rotary latch receptacle provides a 360 degree, full encapsulation of the lower faceplate mating strike post and upper rotary latch mechanism preventing entry or circumvention of the lock mechanism or defeating the latch receptacle because of the semi-rigid nature of the leather saddlebag. The result is an improvement to the typical problem of locking mechanisms on such semi-rigid motorcycle stowage compartments typically referred to as saddlebags. Road bike, motorcycle users have long felt the need for a higher security, tamperproof design to lock and stow gear. Also, the locking mechanism provides a means to attach a guard cover to accomplish further tamperproof features by further defeating the separation of the receptacle and locking pawl components of the lock and latch mechanism.

### BRIEF DESCRIPTION OF THE DRAWING FIGURES

FIG. 1 is an exploded view of the various components and bill of material for a right side lock assembly.

FIG. 2 is an exploded view of the various components and bill of material for a left side lock assembly.

FIG. 3 is a tightened rotary latch in place with an installed actuator spring between the key lever and rotary latch lever.

FIG. 4 is an illustration for the rotating action, branded emblem, flush concealed lock assembly.

### DETAILED DESCRIPTION

Persons of ordinary skill in the art will realize that the following description is illustrative only and not in any way limiting. Other modifications and improvements will readily suggest themselves to such skilled persons having the benefit of this disclosure. In the following description, like reference numerals refer to like elements throughout.

Accordingly, it is a primary object of the present invention to provide a road saddlebag branded emblem aftermarket lock and latch assembly for a left, right, and rear mount saddlebag apparatus.

It is yet another object of this invention to provide a means for providing branded emblem faceplate locking feature and stylized, high security motorcycle and rider gear stowage.

It is yet another object of this invention to provide a method for providing stylistic and high security locking feature on a road saddlebags

It is yet another object of this invention that it can be easily adapted to various types of stylistic, branded emblem designs of the specific faceplate logo and classic road bike, motorcycle designs and that the security locking system is not dependant upon a branded cover plate emblem.

It is yet another object of this invention to provide tamperproof lock and latch mechanism apparatus security by utilizing the rotary latch full encapsulating threaded post and tamper restricting lock guard cover of the lock mechanism.

It is yet another object of this invention to provide a means for resisting tampering and defeating of the lock mechanism through collapsing or deforming the semi-rigid leather saddlebag in order to defeat the integrity of the locking mechanism.

To attain these objects, the present invention discloses a road saddlebag branded emblem aftermarket lock and latch assembly for a left, right, and rear mount saddlebag apparatus. The locking mechanism device of the present invention comprises a distinctive and stylized shape that is held to the rotary latching receptacle at a specific location and orientation on a first end and pivots about a threaded post on the second end. The stylized locking mechanism and branded emblem faceplate are secured about a pivot point and flush to the soft leather, opening pouch of the saddlebag. The visual indication is totally concealed beneath the stylized, branded emblem faceplate. Suitable locking means include, but are not limited to, tubular style computer keyed receptacles and pawl assemblies, hex tool key operated receptacle and pawl assembly and a matching interoperable rotary latch mechanism mounted to the interior of the road saddlebag assembly. Generally these types of locking mechanism features require a mechanical means to properly orient the device to be effected during assembly and mounting.

According to the teaching of the invention, the road saddlebag branded emblem aftermarket lock and latch assembly for a left, right, and rear mount saddlebag apparatus locks a road bike, motorcycle saddlebag of a specific style and design by means of a swivel concealed visual indication of the alignment of an interior rotary latch and a high security locking key which is caused to move by any suitable means, and a mating mounting threaded stud to allow for pivot action indication of the locking mechanism and a means to open a locked saddlebag to gain access to the road bike, motorcycle and rider gear.

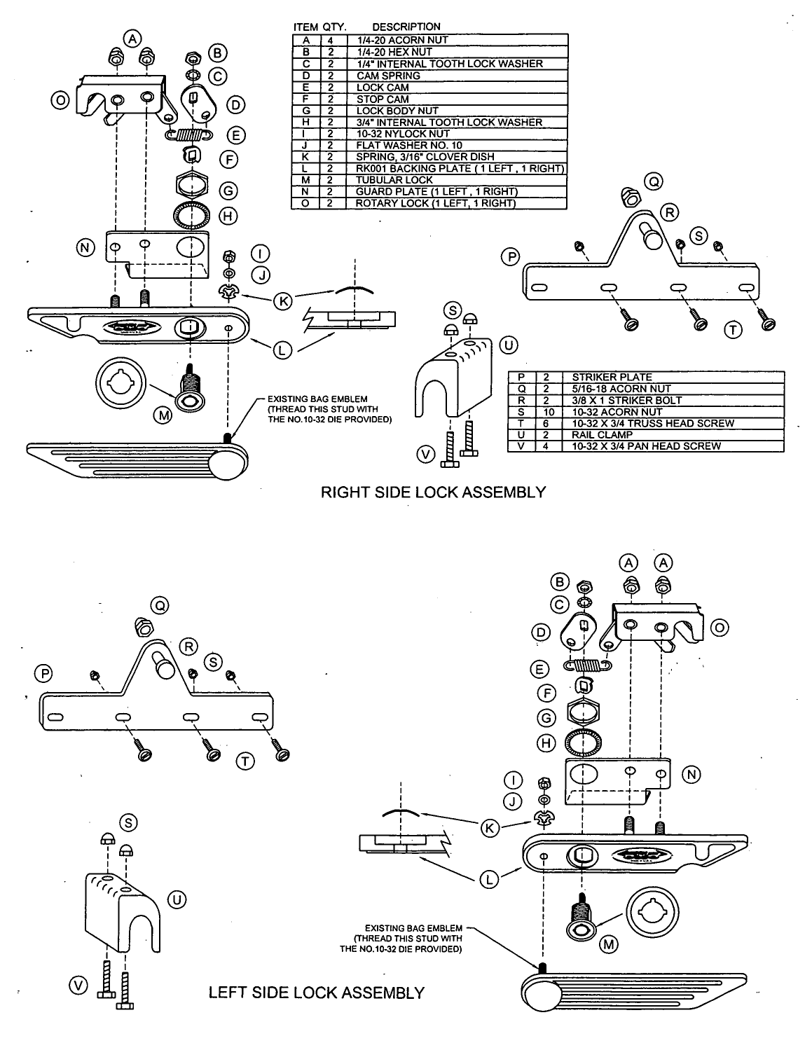

FIG. 1 is an exploded view of the various components and bill of material for a right side lock assembly.

FIG. 2 is an exploded view of the various components and bill of material for a left side lock assembly.

FIG. 3 is a tightened rotary latch in place with an installed actuator spring between the key lever and rotary latch lever.

The rotary latch receptacle mechanism must be properly aligned with the front and bottom faceplate to allow the actuator spring to locate between the key lever and the rotary latch lever. Proper alignment of the rotary latch receptacle, actuator spring and top and bottom faceplate is required for proper operation of the key lock mechanism. Upon proper alignment of the said rotary latch receptacle, actuator spring and faceplates, the locking mechanism will provide high security locking and stylized emblem presentation to the road bike, motorcycle saddlebag assembly.

FIG. 4 is an illustration for the rotating action, branded emblem, flush concealed lock assembly.

Upon the movement of the top cover branded emblem faceplate, the locking mechanism may be concealed or visible to the user and will reset to the closed position when completely aligned with bottom cover branded emblem faceplate. Thus, this embodiment, the concealed locking mechanism and rotating top cover will transverse axially with the bottom cover emblem faceplate about a pivot point centered at the second end. A user will visibly detect the locking mechanism upon pivoting the top faceplate upward about the transverse axis.

While embodiments and applications of this disclosure have been shown and described, it would be apparent to those skilled in the art that many more modifications and improvements than mentioned above are possible without departing from the inventive concepts herein. The disclosure, therefore, is not to be restricted except in the spirit of the appended claims.

What is claimed is:

1. A road saddlebag branded emblem lock and latch assembly for a left, right, and rear mount saddlebag apparatus comprising:
a top and bottom cover plate and recessed, lock and latch mechanism providing stylistic, high security protection for road bike, motorcycle rider gear and a concealed locking mechanism.

2. The apparatus of claim 1 further comprising:
a swivel-pinned cover plate and recessed, lock and latch mechanism providing stylistic and high security protection for road bike, motorcycle rider gear.

3. The apparatus of claim 1 further comprising:
a means for providing branded emblem faceplate locking feature and stylized, high security motorcycle and rider gear stowage.

4. The apparatus of claim 2 wherein
a said branded emblem faceplate locking feature that is selected from the group consisting of a ingnition style high security tubular key lock and a flat key lock receptacle and pawl assembly interlocked to a rotary latch locking assembly.

5. A method for providing stylistic and high security locking feature on a road saddlebag emblem faceplate assembly, comprising the steps of:
Concealing the locking mechanism from visible access indication, preventing improper access to the saddlebag, providing stylised logo emblem presentation consistent with this style road bike, motorcycle saddlebags and facilitating a high security locking mechanism to properly stow a users road bike, motorcycle gear.

6. The apparatus of claim 2 wherein
a said rotary latching mechanism and security keyed mechanism are suitably connected and provide a means to receive a suitably designed striking stud thus providing circumferential entrapment of the striker stud thus preventing the striking stud from being dislodged from the receiving rotary latch as embodied on semi rigid motorcycle road saddlebags and stowage compartments.

7. The apparatus of claim 1 wherein
the aesthetics of the locking mechanism are independent of the rotary latch key guard cover and striker stud security system as used on semi rigid road saddlebags.
